(19) United States
(12) Patent Application Publication
(10) Pub. No.: US 2015/0359701 A1
(43) Pub. Date: Dec. 17, 2015

(54) Massage Apparatus and Methods of Use

(71) Applicant: Jacqueline Mae Moyer, Columbus, GA (US)

(72) Inventor: Jacqueline Mae Moyer, Columbus, GA (US)

(21) Appl. No.: 14/306,263

(22) Filed: Jun. 17, 2014

(51) Int. Cl. A61H 15/00

(52) U.S. Cl. CPC A61H 15/0092

(57) ABSTRACT

A two sided fabric or sleeve sewn together having a center divide configured to create a primary sleeve and an over pressure flap, a compressible ball configured to freely move therein the primary sleeve and the over pressure sleeve is folded over the primary sleeve, thus to enable a hand held massage device capable of deep tissue self-massage of specific body parts.

### TECHNICAL FIELD

The disclosure relates generally to massage or rehabilitation apparatus and more specifically it relates to an elongated sleeve with a freely floating spherical body housed therein.

### BACKGROUND

The disclosure relates generally to massage or rehabilitation devices which function to release tension of strained/tense muscles, and decrease pain. Muscle tightness and pain has plagued many people from tight muscles and trigger points. Trigger points are tiny knots that develop in a muscle when it is overworked or is injured. Muscle tightness and trigger points can be caused by many factors such as: stress, poor posture, musculoskeletal injury, and repetitive movements. To overcome muscle tightness and pain physical therapists, massage therapists, and chiropractors, have developed manual massage techniques, including the use of massage devices, to temporarily relieve patient's muscle tightness and pain.

Various massage or rehabilitation devices are known in the prior art, in particular, there is a hand held stretchy tubular shower device with two or more free rolling within a fixed compartment with an integrated bath-scrub piece. Another has wheels fixated along a cord. Lastly another device is a single channel short rectangular device which has two balls sealed within it. In addition, hand-held rigid devices are known with stationary and rigid protrusions for messaging the neck and other parts. Additionally such devices may have handles or straps positioned at each end of the sleeve to better manage placement of the ball on ones back.

Therefore, it is readily apparent that there is a recognized unmet need for a massage apparatus and methods of use, wherein such apparatus is hand held stretch resistant sleeve with a single free rolling ball positioned within the sleeve with an over pressure flap for adjustable deep tissue massage of specific body areas.

### BRIEF SUMMARY

Briefly described, in an example embodiment, the present apparatus and method overcomes the above-mentioned disadvantage, and meets the recognized need for a massage apparatus and methods of use having, in general, a two sided fabric or sleeve sewn together having a lengthwise center divide configured to create two long compartments or dual channels within the fabric, a sleeve and an over pressure flap, a compressible ball configured to freely move therein the sleeve and, thus to enable a hand held massage device capable of deep tissue massage of specific body parts.

In an exemplary embodiment, a massage apparatus for releasing tension of a muscle, the apparatus having a massage ball, a sleeve, said sleeve to contain said massage ball and said sleeve having a sleeve side edge, an over pressure flap, said over pressure flap having a first flap end, a second flap end, and a flap side edge, and wherein said flap side edge adjoins said sleeve side edge to form an elongated fold edge therebetween.

In still a further exemplary embodiment of the method of self-massaging a specific muscle by a user, said method having the steps of providing a massage apparatus having a massage ball, a sleeve, said sleeve to contain said massage ball and said sleeve having a sleeve side edge, an over pressure flap, said over pressure flap having a first flap end, a second flap end, and a flap side edge, wherein said flap side edge adjoins said sleeve side edge to form an elongated fold edge therebetween, positioning said massage ball therein said sleeve to pre-configure said massage apparatus for the specific muscle, folding said over pressure flap over said sleeve, positioning said massage ball proximate said specific muscle with said sleeve proximate the user and said over pressure flap positioned over said ball, and grasping said first flap end and said second flap end of said over pressure flap.

According to its major aspects and broadly stated, the massage apparatus and methods of use includes a first primary compartment for holding a spherical object or ball and the second compartment used as an over pressure flap onto the primary compartment to provide over pressure onto the ball/spherical object. The primary compartment can be a confined sleeve for the ball or spherical object or upon the discretion of manufacturing be re-sealable on one end to allow the user to change types of spherical objects in the massage apparatus. The secondary compartment includes handles at each end for increased ease of use and to enable the user to control the pressure placed on the muscles. A spherical object such as a tennis ball, a hard solid ball, vibrating spherical object, or a spherical object of which could be cooled or heated. The spherical object has the ability to freely move within the primary sleeve. The user can place the spherical object within the sleeve to the desired position within the sleeve, then fold the secondary compartment over the primary compartment to thus customize the users pin point light to deep tissue massage of specific body parts.

Accordingly, a feature of the massage apparatus and methods of use is its ability to enable an individual person to comfortably position and reposition the hand held minimal to non-elastic cloth sleeve with a single free rolling ball positioned and/or repositionable within the sleeve and via an over pressure flap provide an over pressure force to provide oneself a customized light to deep tissue massage of a selected body part without the assistance of another.

Another feature of the massage apparatus and methods of use is its ability to provide an over pressure flap to enable application of additional force on the ball to achieve a customized and precise light to deep tissue massage of a selected body part.

Still another feature of the massage apparatus and methods of use is its ability to provide a minimal to non-elastic/stretch cloth sleeve with an over pressure flap to enable application of additional force on the ball to achieve a customized and precise light to deep tissue massage of a selected body part.

Yet another feature of the massage apparatus and methods of use is its ability to facilitate the user to press the ball(s) or an object that has been placed into the elongated sleeve with an overpressure force provided by the over pressure flap on the elongated sleeve pressing the ball into a desired muscle, muscle group, or ligaments that demonstrate tightness, soreness/painful, and/or the user feel needs to be massaged.

Yet another feature of the massage apparatus and methods of use is its ability to provide a massage apparatus for massaging a muscle or ligamentous area(s) tightness which causes pain and ultimately causes restricted use of that particular area of the body.

Yet another feature of the massage apparatus and methods of use is its ability to facilitate self-massage with individualized desired pressure on muscles, including but not limited to light massage, deep tissue massage and trigger point massage.

Yet another feature of the massage apparatus and methods of use is its ability to facilitate massage in a variety of body areas, such as but not limited to cervical, thoracic and scapular muscles, and lumbar musculature, gluteal/buttock region, thigh (hamstrings and quadriceps), calf and plantar surface of the foot (bottom of the foot) and the like.

Yet another feature of the massage apparatus and methods of use is its ability to release muscle pain and muscle tension via massage.

Yet another feature of the massage apparatus and methods of use is its ability to enable a person to provide him or herself a self-massage of target muscles without the help of another person.

Yet another feature of the massage apparatus and methods of use is its ability to provide an apparatus that is easy to clean and maintain.

Yet another feature of the massage apparatus and methods of use is its ability to provide a compact, foldable, and portable massage apparatus that is easily stored and transported.

Yet another feature of the massage apparatus and methods of use is its ability to have the manufactured modification of a re-sealable opening at one end of the primary sleeve to allow the user to change the type of ball or spherical object or to add additional balls to the device for a customized and precise light to deep tissue massage.

Yet another feature of the massage apparatus and methods of use is its ability to provide one or more balls having additional functionality such as textured surface, a ball with the ability to be heated or cooled and have it retain such temperature, and a ball with the integration of mechanical vibration.

Yet another feature of the massage apparatus and methods of use is its ability to relieve stress on ones fingers, hands, wrists, and arms when performing a self-massage a selected body part.

Yet another feature of the massage apparatus and methods of use is its ability to provide straps/handles to enable accurate means to apply an additional force by pulling on the straps to achieve a desired deep tissue massage of a selected body part.

Yet another feature of the massage apparatus and methods of use is its ability to accommodate different size and height of the user. The elongated sleeve with handles allows taller individuals to use the apparatus without causing stress on other joints.

Yet another feature of the massage apparatus and methods of use is its ability to pinpoint and massage muscle groups including one's upper and mid-back, shoulders, arms, torso/low back, hips, legs, and feet.

Yet another feature of the massage apparatus and methods of use is its ability to provide a low cost alternative to expensive electro-mechanical massage devices and systems, easily operated by an unskilled masseuse.

Yet another feature of the massage apparatus and methods of use is its ability to provide a resealable opening for the sleeve to add or remove balls.

Yet another feature of the massage apparatus and methods of use is its ability to provide a set of handles or straps positioned at each end of the over pressure flap to enable easy gripping of the massage apparatus and application of the additional force via an over pressure flap to provide oneself a deep tissue massage of a selected body part.

Yet another feature of the massage apparatus and methods of use is its ability to be less expensive and simpler to use than existing technology.

Yet another feature of the massage apparatus and methods of use is its ability to enable one or more balls to move freely within the elongated sleeve so the user can place the ball(s) in a customized position for the target of a specific muscle group.

Yet another feature of the massage apparatus and methods of use is its ability to provide one or more balls not connected to a separate device, such as a cord, rope, string, elastic device, or the like.

Yet another feature of the massage apparatus and methods of use is its ability to provide one or more handles to help a user increase overpressure into the targeted muscle being massaged.

Yet another feature of the massage apparatus and methods of use is its ability to provide the primary compartment with a resealable opening in one edge to enable the user to replace the ball with different size or types of balls.

Yet another feature of the massage apparatus and methods of use is its ability to provide second compartment or flap to be folded over the primary ball compartment to facilitate the overpressure needed for a customized and precise light to deep tissue self-massage.

These and other features of the massage apparatus and methods of use will become more apparent to one skilled in the art from the following Detailed Description of the Embodiments and Claims when read in light of the accompanying drawing Figures.

### BRIEF DESCRIPTION OF THE DRAWINGS

The present massage apparatus and methods of use will be better understood by reading the Detailed Description of the embodiments with reference to the accompanying drawing figures, in which like reference numerals denote similar structure and refer to like elements throughout, and in which:

FIG. 1 is a perspective front view of an example embodiment of the massage apparatus;

FIG. 2 is an exploded view of the massage apparatus of FIG. 1;

FIG. 3 is a cross-section view of the massage apparatus of FIG. 1, shown over pressure flap folded over the primary sleeve with one ball;

FIG. 3B is a side edge view of the massage apparatus of FIG. 1, shown how it is folded;

FIG. 4 is a back side view of massage apparatus of FIG. 1 shown in use with the ball positioned on a user's upper trapezius muscle;

FIG. 5 is a back side view of massage apparatus of FIG. 1 shown in use with the ball positioned on a user's mid-back specifically rhomboids/middle trapezius muscles;

FIG. 6 is a side view of massage apparatus of FIG. 1 shown in use with the ball positioned on a user's scapular muscles/mid-back;

FIG. 7 is a back side view of massage apparatus of FIG. 1 shown in use with the ball positioned on a user's lumbar; and

FIGS. 8A and 8B is a flow diagram of a method of using the massage apparatus to self-massage a specific muscle by a user.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

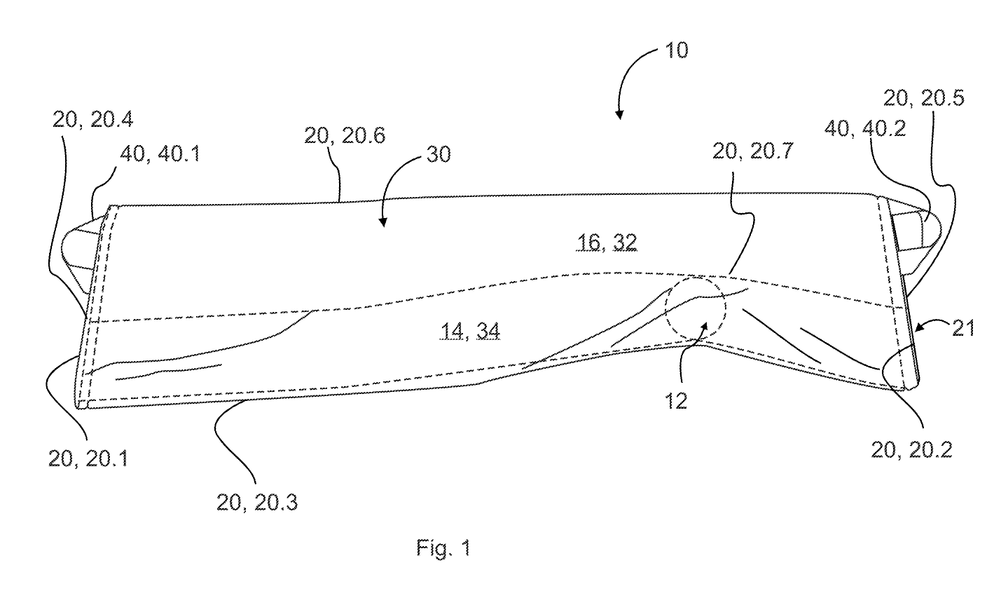

In describing the exemplary embodiments of the present disclosure, as illustrated in FIGS. 1-8 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

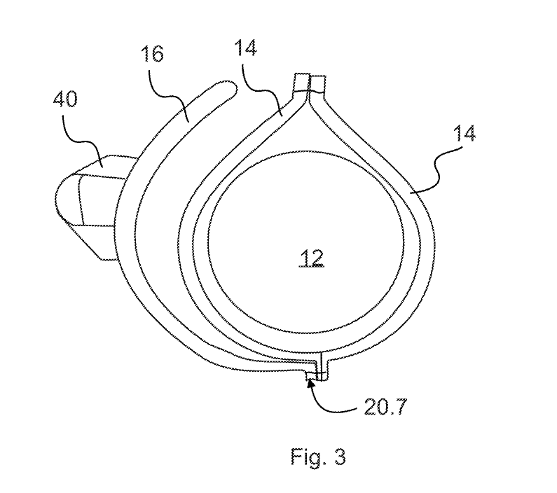

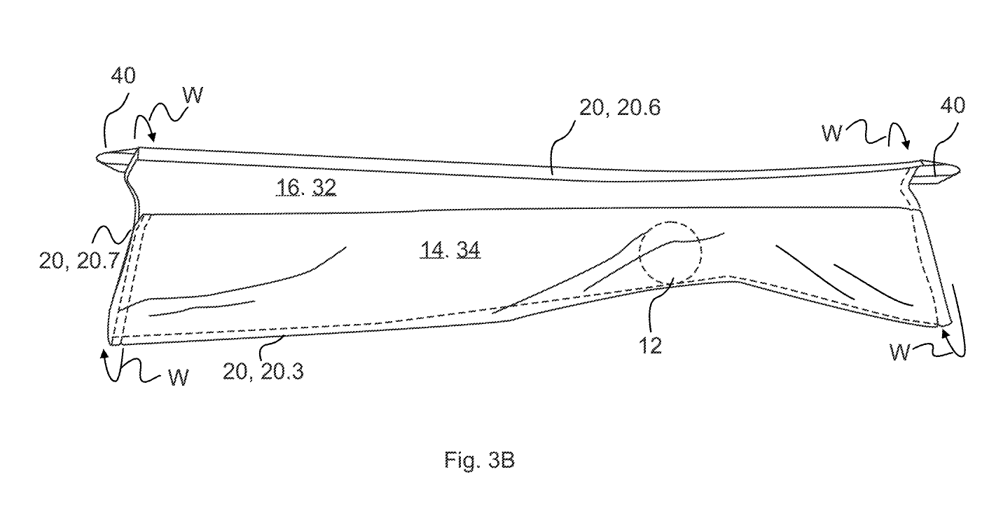

Referring now to FIGS. 1-3, by way of example, and not limitation, there is illustrated exemplary embodiment of a massage or rehabilitation device, such as massage apparatus 10. Preferably, massage apparatus 10 includes a spherical ball, massage ball, spherical massage object, or object, preferably range in size of approximately 2-3 inches in diameter, such as ball 12 enclosed in an elongated sleeve or two sided fabric sewn together and having a center divide configured to create sleeve 14 and a flap, such as over pressure flap 16, wherein ball 12 may be housed, contained, enclosed, retained, positioned, repositioned, or freely moved therein sleeve 14 or may be strategically positioned within sleeve 14 to massage specific a muscle or group of muscles. Moreover, massage apparatus 10 may be configured with a plurality of edges 20 dimensioned to accommodate massage apparatus 10 preferably as a hand held massage device capable of deep tissue massage of specific body parts. Edges 20 may preferably include a first sleeve end, such as sleeve top edge 20.1, second sleeve end, such as sleeve bottom edge 20.2, a sleeve side edge, such as sleeve side edge 20.3, a first flap end, such as over pressure flap top edge 20.4, a second flap end, such as over pressure flap bottom edge 20.5, a flap side edge, such as over pressure flap side edge 20.6, and an adjoining side edge, sewn interior seam, or an extension therefrom, such as elongated fold edge 20.7 preferably configured therebetween sleeve 14 and over pressure flap 16 (preferably as a sewn seam through the length of massage apparatus 10 to join, adjoin, or affix sleeve 14 and over pressure flap 16) where sleeve 14 and over pressure flap 16 are preferably affixed thereto one another as foldable parts, one folded over the other or itself, as shown in FIG. 3.

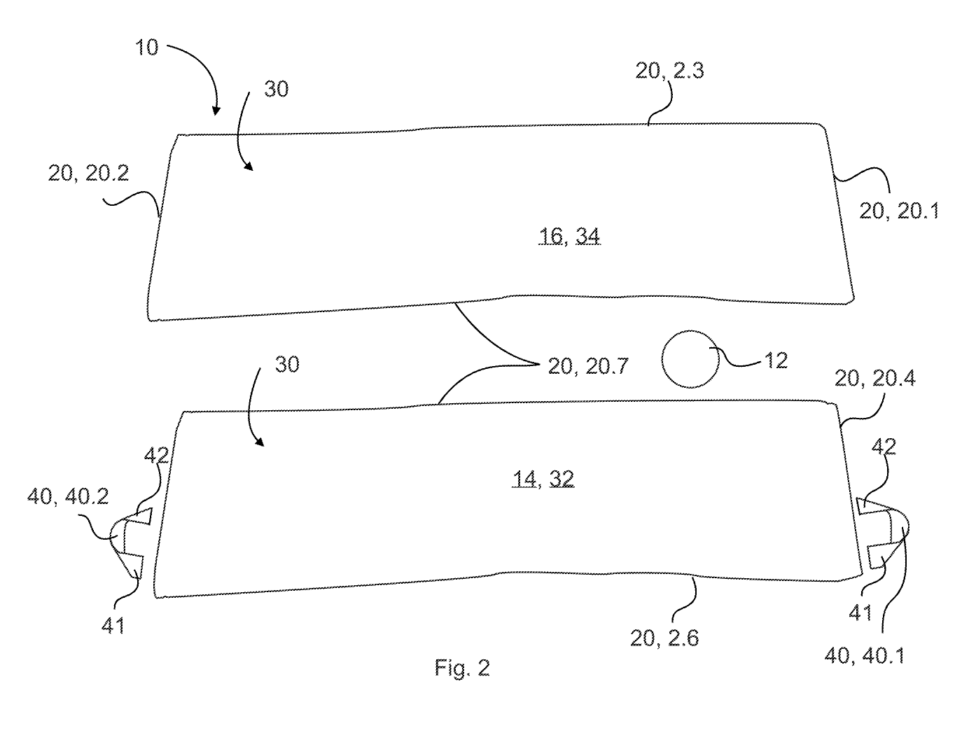

Referring now to FIG. 2, by way of example, and not limitation, there is illustrated an exploded view of an example embodiment of massage apparatus 10. Massage apparatus 10 preferably includes folded or pieced fabric, such as fabric 30 constructed, formed or configured of top layer 32 and bottom layer 34. Preferably top layer 32 and bottom layer 34 of fabric 30 may be affixed one to the other along edge 20 to form massage apparatus 10. In addition, top layer 32 and bottom layer 34 of fabric 30 may be affixed one to the other along elongated fold edge 20.7, shown in FIG. 1, to form sleeve 14 and over pressure flap 16.

It is contemplated herein that other configurations of massage apparatus 10 are included herein, such fabric 30 may include top layer 32 and bottom layer 34 or sleeve 14 and over pressure flap 16 as separate pieces and such pieces may be affixed together along elongated fold edge 20.7, or over pressure flap 16 may include a single layer and sleeve 14 includes a folded piece having affixed edges 20, such as sleeve top edge 20.1, sleeve bottom edge 20.2, and elongated fold edge 20.7, and the like.

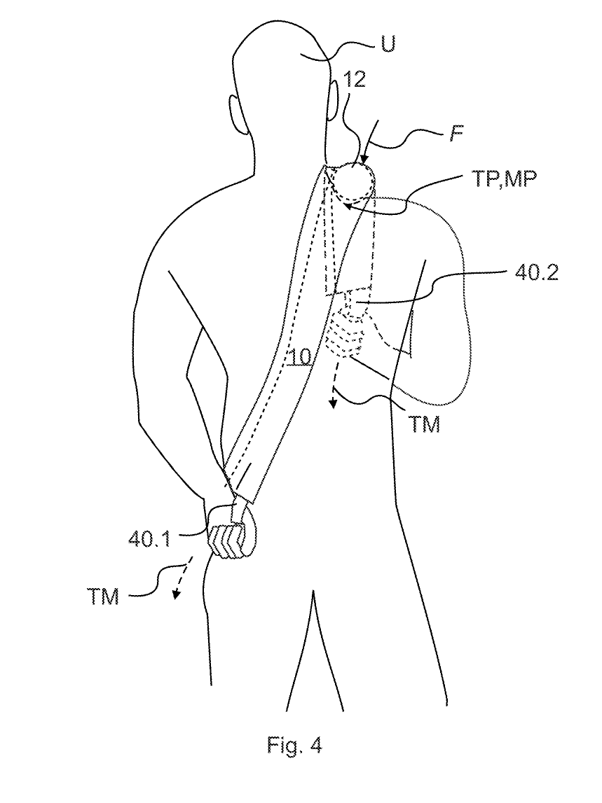

It is further contemplated herein that massage apparatus 10 having sleeve 14 and over pressure flap 16 is preferably configured to enable application of an additional or overpressure force, such as force F on ball to achieve a deep tissue massage of a selected body part, as shown in FIGS. 4-7.

It is still further contemplated herein that top layer 32 and bottom layer 34 of sleeve 14 and over pressure flap may be affixed, such as joined, bonded, sewn, or otherwise affixed one to the other.

It is still further contemplated herein that top layer 32 and bottom layer 34 of sleeve 14 and over pressure flap may be substantially rectangular pieces of fabric or material and affixed one to the other as sewn cloth that has minimal to no flexibility or elasticity.

In an exemplary embodiment top layer 32 and bottom layer 34 are preferably sewn together into an elongate rectangle with the dimensions of approximately 32-36 inches in length (sleeve side edge 20.3, over pressure flap side edge 20.6, and elongated fold edge 20.7) by approximately 7-10 inches in width (sleeve top edge 20.1 and over pressure flap top edge 20.4, sleeve bottom edge 20.2 and over pressure flap bottom edge 20.5). Other dimensions for massage apparatus 10 are contemplated herein. Moreover, sleeve side edge 20.3 and over pressure flap side edge 20.6 should be of sufficient length so as to permit massage apparatus 10 to be used to massage a muscle or group of muscles on both sides of the body and reach all areas of the back. Sleeve top edge 20.1 and over pressure flap top edge 20.4, and sleeve bottom edge 20.2 and over pressure flap bottom edge 20.5, should be of sufficient width, such as larger than the diameter of ball 12 and permitting enough space to enable ball 12 to move freely within sleeve 14.

It is recognized herein that sleeve 14 may include a re-sealable opening or slit, such as re-sealable slot 21 to enable insertion and/or retrieval of ball 12 from sleeve 14. Re-sealable slot 21 is preferably dimensioned to enable ball 12 to be inserted therein or pass therein sleeve 14 or to enable ball 12 to be removed therefrom sleeve 14. It is contemplated herein that re-sealable slot 21 may be configured therein sleeve side edge 20.3.

Sleeve 14 and over pressure flap 16 are preferably formed of a suitable material or woven fabric, such as cotton, silk, linen, rayon, acrylic, nylon, polyester, duck cloth, fabric with brushed twill lining, or vinyl, canvas, plastic, rubber, polyurethane, fiber, coated fiber or mesh, nylon, Tyvek, or the like, capable of providing structure to massage apparatus 10. Preferably, the material includes other suitable characteristics, such as minimal to no elastic/non-stretch properties, durability, strength, water resistant, stretch resistant, puncture resistant, tear resistant, light weight, chemical inertness, oxidation resistance, ease of workability, or other beneficial characteristic understood by one skilled in the art.

It is further contemplated herein that massage apparatus 10 may be configured and/or sized to accommodate various sized users U by adjustment of massage apparatus 10 dimensions (the length and width may be decreased or increased).

It is still further contemplated herein that massage apparatus 10 provides a compact, foldable, and portable massage apparatus 10 that is easily stored and transported.

It is still further contemplated herein that sleeve 14 and over pressure flap 16 of massage apparatus 10 preferably include minimal to non-stretch/non-elastic properties or capability to increase or maximize the overpressure provided by over pressure flap 16 onto sleeve 14 and ball 12, thus the pushing or application of force F on ball 12 into the desired region or tissue of the body.

Preferably ball 12 may be a semi-compressible ball configured to freely move therein sleeve 14 and, thus to enable hand held massage apparatus 10 to be capable of deep tissue massage of specific body parts or adapted to be used in accordance with specific exercises for massaging all major muscle groups. Moreover, ball 12 may include tennis ball, solid or hollow, rubber, foam or plastic ball, additional functionality such as compressible, semi-compressible, textured surface, the ability to be heated or cooled or an element therein has such characteristics, and have it retain such temperature for transfer to tissue, the integration of mechanical vibration, and the like to achieve a variety of deep tissue massage thereof selected body parts. Preferably, the material of ball 12 includes other suitable characteristics, such as durability, flexibility, resistance, frictional surface, optimally sized, strength, water resistant, compressible, light weight, textured, chemical inertness, oxidation resistance, or other beneficial characteristic understood by one skilled in the art. Moreover, ball 12 should be sufficiently strong to provide desired pressure to a specific tissue, muscle or group of muscles.

It is contemplated herein that one or more balls may be positioned within sleeve 14 so the user can place ball(s) 12 in a customized position for the target of a specific muscle group.

Over pressure flap 16 may include a plurality of hand grips, loops, or handles, such as pair of or one or more straps 40, having a first strap end 41 and a second strap end 42 joined, bonded, sewn, or otherwise affixed to one of edges 20 of over pressure flap 16. Preferably first strap 40.1 may preferably be affixed to over pressure flap top edge 20.4 and second strap 40.2 may preferably be affixed to over pressure flap bottom edge 20.5. Straps 40 are preferably configured to relieve stress of a user's fingers, hands, wrists, and arms when performing a self-massage to a selected body part and moreover, straps 40 enable accurate placement of ball 12 and a means to apply a tugging motion TM, as shown in FIGS. 3-7, by pulling or tugging on the straps to achieve a deep tissue massage of a selected body part.

It is contemplated herein that straps 40 may be configured to enable accurate placement of ball 12 and a means to apply an additional force F by pulling on the straps to achieve a deep tissue massage of a selected body part.

It is further contemplated herein that straps 40 may be configured to help a user U increase overpressure force into the targeted muscle being massaged.

It is still further contemplated herein that sleeve 14 may include a plurality of hand grips, loops, or handles, such as pair of or one or more straps 40 joined, bonded, sewn, or otherwise affixed to one of edges 20 of sleeve 14.

Referring now to FIGS. 3 and 3B, by way of example, and not limitation, there is illustrated a cross-sectional view of massage apparatus 10. Preferably massage apparatus 10 may be folded along elongated fold edge 20.7 preferably configured with ball 12 encased, contained, or enveloped by sleeve 14 and over pressure flap 16 folded or laid over sleeve 14 from where sleeve 14 and over pressure flap 16 are preferably affixed thereto one another. In use, over pressure flap 16 is preferably folded or laid over, as shown by wrapped direction arrows W, over sleeve 14 with ball 12 freely positioned or repositioned therein sleeve 14.

It is contemplated herein that sleeve 14 and over pressure flap 16 enable application of additional force F on ball 12 to provide oneself a customized light to deep tissue massage of a selected body part without the assistance of another.

Referring now to FIGS. 4-7, by way of example, and not limitation, there is illustrated a view of massage apparatus 10 shown in use by user U. A user U of massage apparatus 10, preferably positions ball 12 on, above, adjacent, proximate a body part in need of massage and grasps the ends or edges 20 of over pressure flap 16, such as over pressure flap top edge 20.4 and over pressure flap bottom edge 20.5, or grips first strap 40.1 affixed to over pressure flap top edge 20.4 and grips second strap 40.2 affixed to over pressure flap bottom edge 20.5. As shown in FIG. 4, a user U of massage apparatus 10, preferably positions ball 12 on user's U neck or upper trapezius TP, either of the two large flat triangular muscles that run from the back of the neck and cover each posterior neck and shoulders. One's upper trapezius TP is the muscle that moves the shoulder blades and draws the head backward. User U grasps the ends or edges 20 of over pressure flap 16, such as over pressure flap top edge 20.4 and over pressure flap bottom edge 20.5, or grips first strap 40.1 affixed to over pressure flap top edge 20.4 and grips second strap 40.2 affixed to over pressure flap bottom edge 20.5 and pulls or tugs, tugging motion TM, over pressure flap top edge 20.4 and over pressure flap bottom edge 20.5 there apart. Such separation and pulling, such as tugging motion TM of over pressure flap 16 causes an over pressure or additional force, such as force F directed toward top of ball 12, and thus pushes ball 12 deeper into user's U upper trapezius TP to provide a customized light to deep tissue massage of user's U upper trapezius TP without the assistance of another.

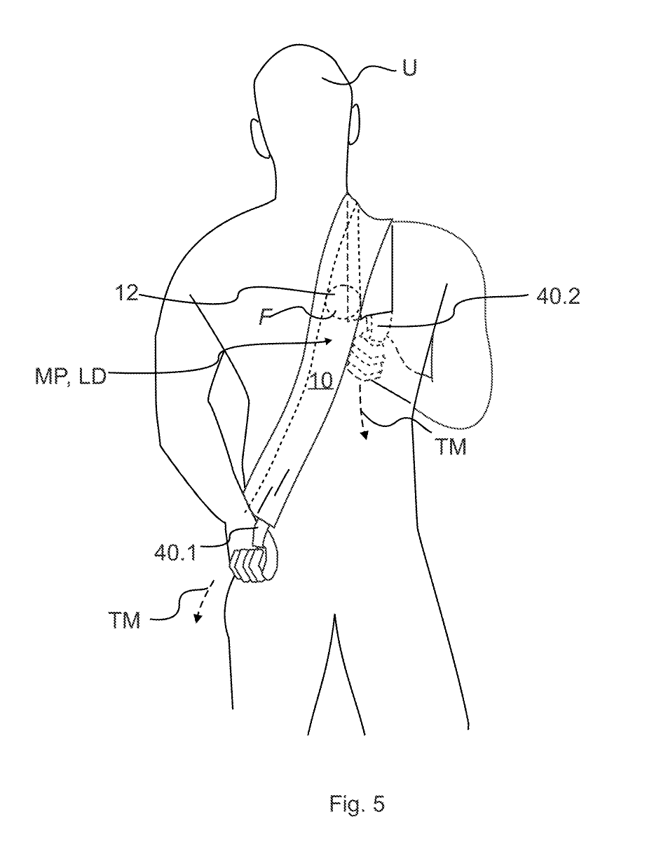

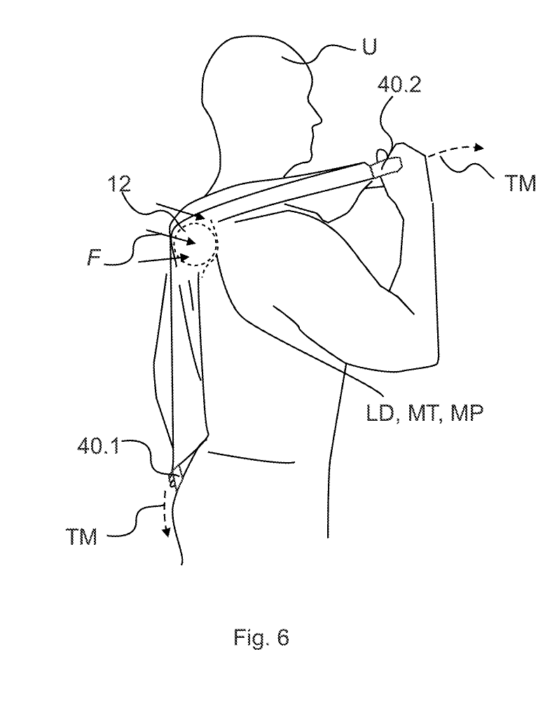

As shown in FIGS. 5 and 6, a user U of massage apparatus 10, preferably positions ball 12 on user's U middle trapezius/rhomboids/scapular muscles LD. The middle trapezius/rhomboids/scapular LD assist with retraction and elevation of the shoulder blades. User U grasps the ends or edges 20 of over pressure flap 16, such as over pressure flap top edge 20.4 and over pressure flap bottom edge 20.5, or grips first strap 40.1 affixed to over pressure flap top edge 20.4 and grips second strap 40.2 affixed to over pressure flap bottom edge 20.5 and pulls or tugs, tugging motion TM, over pressure flap top edge 20.4 and over pressure flap bottom edge 20.5 there apart. Such separation and pulling, such as tugging motion TM of over pressure flap 16 causes or results in force F directed toward top of ball 12 (facing viewer), and thus pushes ball deeper into user's U muscle tissue MT to provide a customized light to deep tissue massage of user's U middle trapezius/rhomboids/scapular LD without the assistance of another.

Referring now to FIG. 6, by way of example, and not limitation, there is illustrated a side view of massage apparatus 10 penetrating muscle tissue MT. In use, tugging motion TM of over pressure flap 16 causes or results in force F directed toward top of ball 12, and thus pushes ball 12 deeper into user's muscle tissue MT to provide a customized light to deep tissue massage of user's U muscle tissue MT.

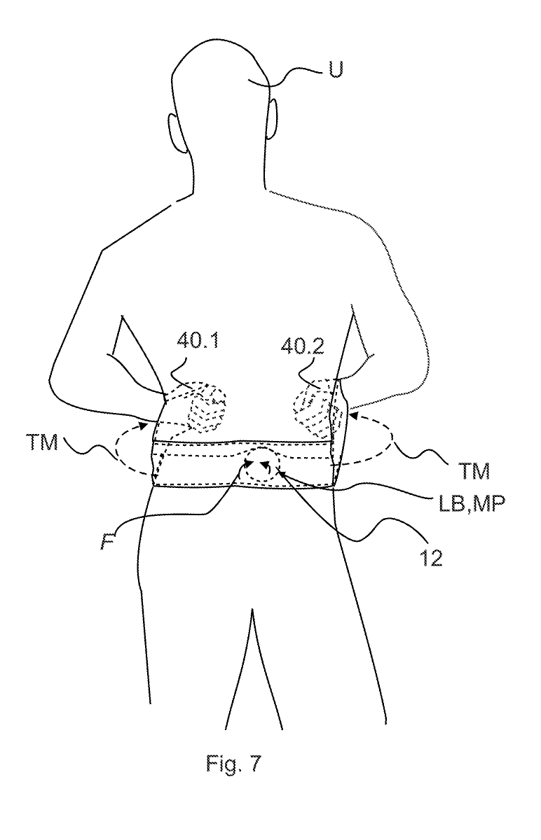

As shown in FIG. 7, a user U of massage apparatus 10, preferably positions ball 12 on user's U lumbar LB, such as lattissimus dorsi which is the widest and most powerful muscle of the back. It is a large, flat, triangular muscle which covers the lumbar region and the lower half of the thoracic region. User U grasps the ends or edges 20 of over pressure flap 16, such as over pressure flap top edge 20.4 and over pressure flap bottom edge 20.5, or grips first strap 40.1 affixed to over pressure flap top edge 20.4 and grips second strap 40.2 affixed to over pressure flap bottom edge 20.5 and pulls or tugs, tugging motion TM, over pressure flap top edge 20.4 and over pressure flap bottom edge 20.5 there apart. Such separation and pulling, such as tugging motion TM of over pressure flap 16 causes or results in force F directed toward top of ball 12 (facing viewer), and thus pushes ball 12 deeper into user's U lumbar LB to provide a customized light to deep tissue massage of user's U lumbar LB without the assistance of another.

It is recognized herein that massage apparatus 10 may be utilized to massage the primary muscles of the body, including, but not limited to, cervical, scalene muscles, levator scapulae, upper/middle/lower trapezius muscle, thoracic spine, such as rhomboid, scapular muscles, such as supraspinatus muscle, infraspinatus muscle, teres minor, lumbar such as Latissimus dorsi, quadratus lumborum, and the like.

It is contemplated herein that user U may rock tugging motion TM back and forth to massage user's muscle or muscle group.

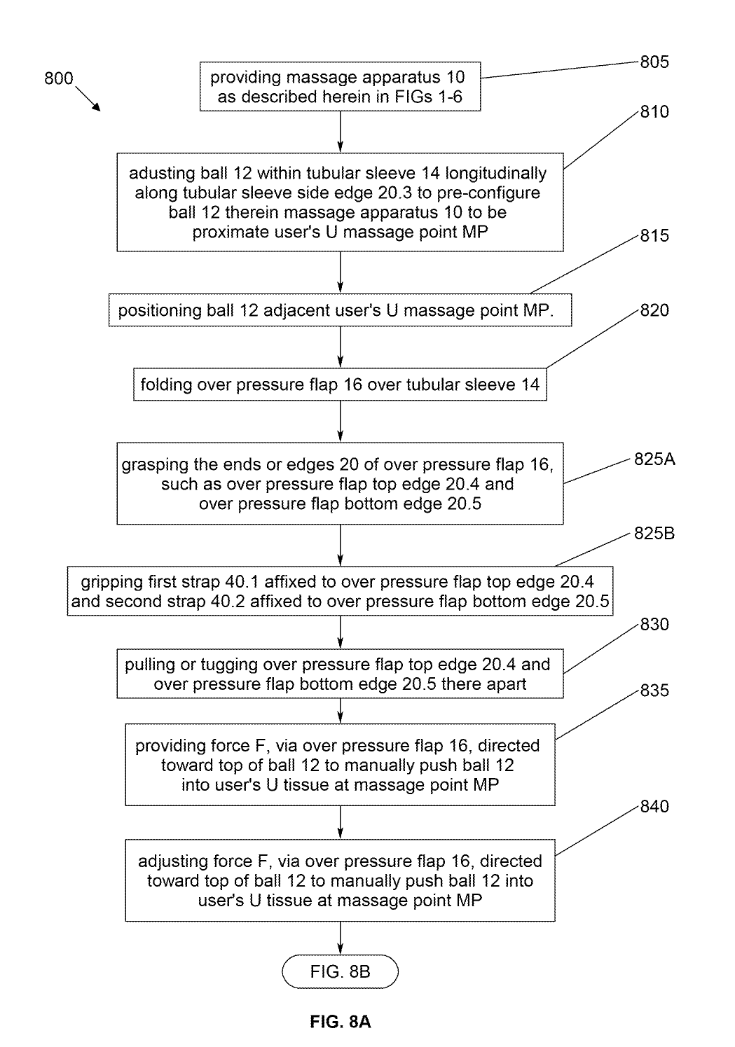

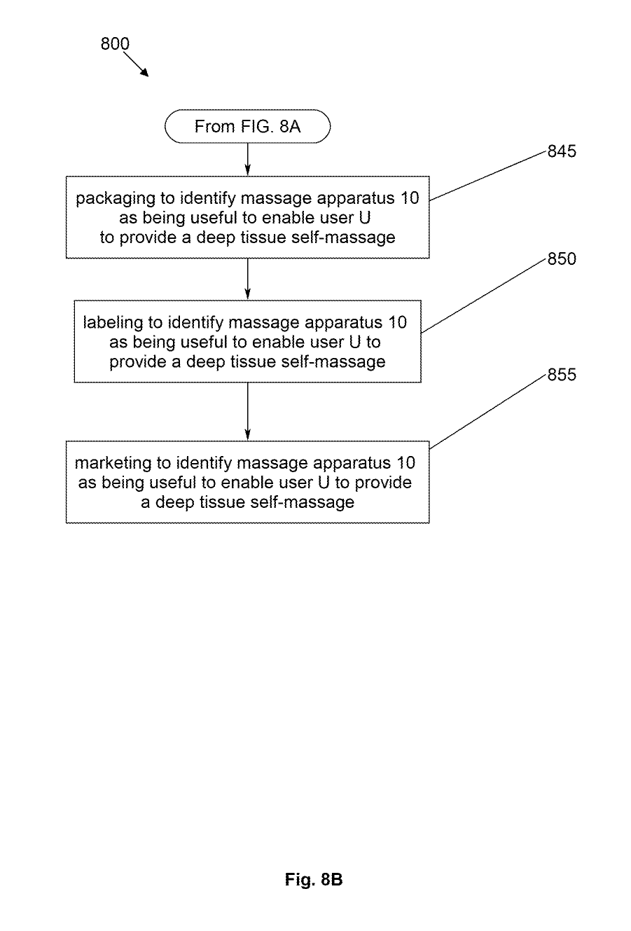

Referring now to FIGS. 8A and 8B, there is illustrated a flow diagram 800 of a method of positioning, self-massaging, providing, and marketing, the user U massage apparatus 10 as described herein in FIGS. 1-7. In block or step 805, providing massage apparatus 10 as described herein in FIGS. 1-6. In block or step 810, adjusting or positioning ball 12 within sleeve 14 longitudinally along sleeve side edge 20.3 to pre-configure ball 12 therein massage apparatus 10 to be proximate user's U tense muscle, trigger point or muscle group, such as massage point MP. In block or step 815, positioning ball 12 adjacent, above, or proximate user's U massage point MP with sleeve 14 touching user U and over pressure flap 16 positioned over ball 12. In block or step 820, folding over pressure flap 16 over sleeve 14 with ball 12 freely positioned therein sleeve 14, as shown by wrapped direction arrows W. Steps 815 and 820 may be interchanged. In block or step 825 grasping the ends or edges 20 of over pressure flap 16, such as over pressure flap top edge 20.4 and over pressure flap bottom edge 20.5, or gripping first strap 40.1 affixed to over pressure flap top edge 20.4 and second strap 40.2 affixed to over pressure flap bottom edge 20.5. In block or step 830 pulling or tugging over pressure flap top edge 20.4 and over pressure flap bottom edge 20.5 there apart (tugging motion TM). In block or step 835 providing force F, via over pressure flap 16, directed toward top of ball 12 to manually push ball 12 into user's U tissue at massage point MP, or providing a customized light to deep tissue massage at massage point MP. In block or step 840 adjusting or modifying force F, via over pressure flap 16, directed toward top of ball 12 to manually push ball 12 into user's U tissue at massage point MP. A harder tugging motion TM on ends or edges 20 of over pressure flap 16, such as over pressure flap top edge 20.4 and over pressure flap bottom edge 20.5, or gripping first strap 40.1 affixed to over pressure flap top edge 20.4 and second strap 40.2 affixed to over pressure flap bottom edge 20.5 results in an additional or over pressure force, such as force F, via over pressure flap 16, directed toward top of ball 12 to manually push ball 12 further into user's U tissue at massage point MP, thus providing a deeper tissue massage at massage point MP. Moreover, user U can control the amount of overpressure (force F) on ball 12 by adjusting, pulling up and down or rocking tugging motion TM the user U can control the amount of overpressure (force F) on ball 12 enabling user U to provide themselves a customized pressure massage to the target muscles from a light to deep tissue massage.

In block or step 845, packaging to identify massage apparatus 10 as being useful to enable user U to provide a deep tissue self-massage as set forth herein. In block or step 850, labeling to identify massage apparatus 10 as being useful to enable user U to provide a deep tissue self-massage as set forth herein. In block or step 855, marketing to identify massage apparatus 10 as being useful to enable user U to provide a deep tissue self-massage as set forth herein.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A massage apparatus for releasing tension of a muscle, the apparatus comprising: a massage ball;
a sleeve, said sleeve to contain said massage ball and said sleeve having a sleeve side edge;
an over pressure flap, said over pressure flap having a first flap end, a second flap end, and a flap side edge;
and wherein said flap side edge adjoins said sleeve side edge to form an elongated fold edge therebetween.

2. The apparatus of claim 1, wherein said sleeve and said over pressure flap are constructed from a substantially rectangular piece of fabric folded on itself.

3. The apparatus of claim 1, wherein said sleeve and said over pressure flap are constructed from two substantially rectangular pieces of fabric.

4. The apparatus of claim 1, further comprising a pair of straps, said pair of straps having a first strap end and a second strap end, a first strap of said pair of straps configured with said first strap end and said second strap end affixed thereto said first flap end and a second strap of said pair of straps configured with said first strap end and said second strap end affixed thereto said second flap end.

5. The apparatus of claim 1, wherein said ball is semi-compressible.

6. The apparatus of claim 1, wherein said sleeve is configured to enable said ball to be freely positioned therein by the user.

7. The apparatus of claim 1, wherein said ball encased in said sleeve is positioned above the muscle.

8. The apparatus of claim 7, wherein said over pressure flap is folded over said sleeve along said elongated fold edge.

9. The apparatus of claim 8, wherein said over pressure flap provides a force on said ball.

10. The apparatus of claim 4, wherein said ball encased in said sleeve is positioned above the muscle.

11. The apparatus of claim 10, wherein said over pressure flap is folded over said sleeve along said elongated fold edge.

12. The apparatus of claim 11, wherein said over pressure flap provides a force on said ball.

13. The apparatus of claim 1, wherein said sleeve further comprises a re-sealable slot configured in said sleeve.

14. The apparatus of claim 13, wherein said re-sealable slot is dimensioned to enable said ball to be inserted therein said sleeve.

15. A method of self-massaging a specific muscle by a user, said method comprising the steps of:
providing a massage apparatus having a massage ball, a sleeve, said sleeve to contain said massage ball and said sleeve having a sleeve side edge, an over pressure flap, said over pressure flap having a first flap end, a second flap end, and a flap side edge, wherein said flap side edge adjoins said sleeve side edge to form an elongated fold edge therebetween;
positioning said massage ball therein said sleeve to pre-configure said massage apparatus for the specific muscle;
folding said over pressure flap over said sleeve;
positioning said massage ball proximate said specific muscle with said sleeve proximate the user and said over pressure flap positioned over said ball; and
grasping said first flap end and said second flap end of said over pressure flap.

16. The method of claim 15, further comprising the step of pulling said first flap end and said second flap end of said over pressure flap there apart.

17. The method of claim 16, further comprising the step of providing a force via said over pressure flap on said ball to manually push said ball into the specific muscle of the user.

18. The method of claim 17, further comprising the step of adjusting said force via said over pressure flap on said ball to manually push said ball into the specific muscle of the user.

19. The method of claim 15, further comprising the step of packaging said massage apparatus to identify said massage apparatus as being useful to provide a self-massage of the specific muscle of the user.

20. The method of claim 15, further comprising the step of labeling said massage apparatus to identify said massage apparatus as being useful to provide a self-massage of the specific muscle of the user.

21. The method of claim 19, further comprising the step of marketing said massage apparatus to identify said massage apparatus as being useful to provide a self-massage of the specific muscle of the user.
